(19) United States
(12) Patent Application Publication
(10) Pub. No.: US 2022/0351017 A1
(43) Pub. Date: Nov. 3, 2022

(54) CIRCUIT FOR EXTRACTING FEATURES, NEURAL NETWORK AND SIGNAL PROCESSING SYSTEM

(71) Applicant: HANG ZHOU NANO CORE CHIP ELECTRONIC TECHNOLOGY CO., LTD, Hangzhou (CN)

(72) Inventors: Le Ye, Hangzhou (CN); Zhixuan Wang, Hangzhou (CN); Ru Huang, Hangzhou (CN); Ying Liu, Hangzhou (CN); Yangyuan Wang, Hangzhou (CN)

(21) Appl. No.: 17/731,283

(22) Filed: Apr. 28, 2022

(30) Foreign Application Priority Data
Apr. 29, 2021 (CN) 202110476072.3

(51) Int. Cl. G06N 3/04; G06N 3/063

(52) U.S. Cl. CPC G06N 3/049; G06N 3/0635

(57) ABSTRACT

The present application discloses a circuit for extracting a feature, a network and a signal processing system. The circuit includes: one or more instant range of change feature extracting units, which are connected in parallel and configured to extract and classify an instant range of change (IROC) feature from an input of an asynchronous pulse coding in the time domain, the input of the asynchronous pulse coding is a pulse request signal and a pulse direction signal obtained by performing time-domain quantization and coding on an analog signal. By the circuit for extracting a feature according to the present application, the instant range of change of an analog input of the asynchronous pulse coding can be directly extracted and classified in the time domain, converting from the time domain to the frequency domain required by the traditional feature extraction process is avoided, and the power consumption overhead is reduced.

The present disclosure claims the priority of Chinese patent application under CN202110476072.3 filed on Apr. 29, 2021. The contents of the aforementioned application are incorporated herein by reference in its entirety.

### TECHNICAL FIELD

The present application relates to the technical field of integrated circuits, in particular to a circuit for extracting features, a neural network and a signal processing system.

### BACKGROUND

With the rapid development of society, the number of various electronic application devices is exploding, and these electronic devices are becoming more and more intelligent which also poses strict requirements on the power consumption and cost of chips. These intelligent electronic devices often adopt small-capacity batteries to balance factors such as cost, size, and weight. In order to avoid unacceptable material costs and labor costs caused by frequent replacement of batteries, chips need to have extremely low power consumption.

A data processing method used in the traditional chip is synchronous, and the traditional chip has circuit designed using a traditional synchronous digital circuit design method. In contrast, asynchronous data processing methods have proven to have an advantage of power consumption. The intelligent chip needs to perform feature extraction first when performing intelligent processing on input analog signal. A traditional feature extraction method includes firstly converting a time domain signal into a frequency domain signal (for example, through a fast Fourier transform circuit, etc.), and then performing feature extraction in the frequency domain. The process is completed through a synchronous data processing method and converting from the time domain to the frequency domain will result in additional power consumption overhead.

In recent years, an ADC (Analog-to-Digital Converter) based on a new Level Crossing (LC) sampling mode, namely LC-ADC, has been widely developed. The ADC based on the new sampling mode only performs sampling when the signal changes. The more drastic the signal change, the higher the sampling frequency, and the ADC has a very low sampling frequency to maintain ultra-low power consumption when the signal is smooth. Therefore, the ADC based on an event-driven adaptive sampling mode has ultra-low power advantages in applications such as Internet of Things. The output of this ADC is in the form of asynchronous pulses, that is, asynchronous pulse coding, i.e., time-domain quantization coding, is performed on the analog signal, and two signals are output by time-domain quantization code. The output pulse request signal Req represents that the ADC has performed a sampling once, and an output pulse direction signal Dir represents that the change direction of the analog signal is increasing, and Dir is zero when the direction is decreasing. Therefore, when this sampling mode is used for information collection in electronic device chips, how to directly extract feature information contained in the two asynchronous pulse signals in the time domain is a technical problem that needs to be considered.

### BRIEF SUMMARY

The present application provides a circuit for extracting features, a neural network and a signal processing system which can solve the technical problem of directly performing feature extraction on two asynchronous pulse signals in a time domain.

The present application provides a circuit for extracting features, including: one or more feature extracting units, configured to extract and classify an instant range of change (IROC) feature from an inputs of an asynchronous pulse coding in the time domain, wherein the inputs of the asynchronous pulse coding comprise a pulse request signal and a pulse direction signal obtained by performing time-domain quantization and coding on an analog signal.

The present application further provides a pulse neural network, including the above circuit for extracting features.

The present application further provides a signal processing system, including the above circuit for extracting features.

By the circuit for extracting features according to the embodiment of the present application, the instant range of change of an analog input of the asynchronous pulse coding can be directly extracted and classified in the time domain, and the instant range of change is used as the feature thereof. By adopting this method, converting from the time domain to the frequency domain required by the traditional feature extraction process is avoided, the power consumption overhead is reduced and the signal range of change, also known as the time differential of the signal, contains all the information of the signal in the time domain, and thus the method for extracting the feature of the signal provides lower power consumption without losing information.

### BRIEF DESCRIPTION OF THE DRAWINGS

In order to more clearly illustrate the technical solutions disclosed in the embodiments of the present application or the prior art, drawings needed in the descriptions of the embodiments or the prior art will be briefly described below. The drawings in the following description are only some of the embodiments of the present application, and other drawings can be obtained according to these drawings without any creative effort for those skilled in the art.

FIG. 1 is a schematic diagram showing a principle of a circuit for extracting features according to an embodiment of the present application;

FIG. 2 is a schematic diagram showing a circuit for extracting features according to an embodiment of the present application;

FIG. 3 is a circuit structure diagram of an instant range of change (IROC) unit in a circuit for extracting features according to an embodiment of the present application; and

FIG. 4 is an operation timing diagram of the IROC unit in FIG. 3.

### DETAILED DESCRIPTION

In order to illustrate the objectives, technical solutions and advantages of the present application clearly, the technical solutions in the embodiments of the present application will be described clearly and completely in conjunction with the accompanying drawings in the embodiments of the present application. The described embodiments are part of the embodiments of the present application, rather than all of the embodiments. All other embodiments obtained by a person of ordinary skill in the art based on the embodiments of the present utility model without any creative effort fall within the protection scope of the present utility model.

In order to explain the technical solution of the present application clearly, the embodiments of the present application are described in detail in conjunction with the accompanying drawings

Physical signals collected by various sensor nodes have information in two dimensions of amplitude and time, and the differential of amplitude of signal to time contains information of two dimensions, and the integration of differential to time can also reconstruct the signal. Therefore, the differential can represent a feature of the signal in the time domain.

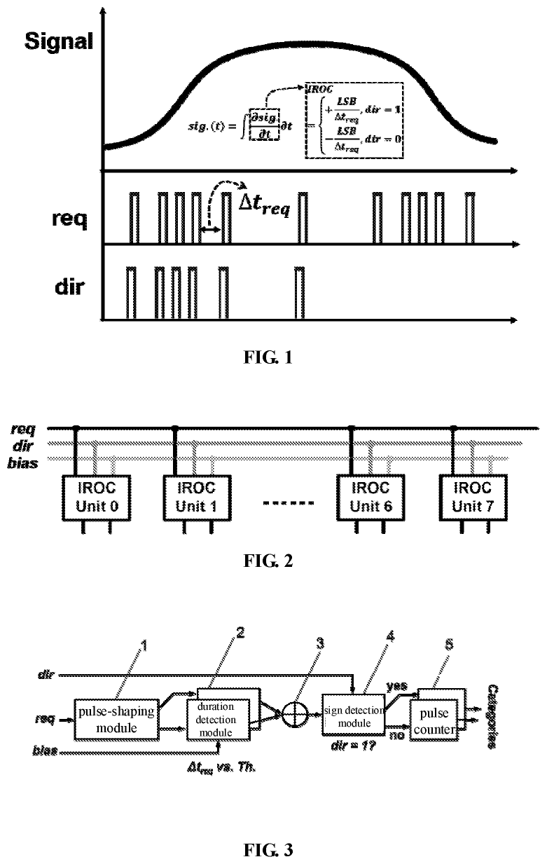

FIG. 1 is a schematic diagram showing a principle of a circuit for extracting features according to an embodiment of the present application. As shown in FIG. 1, an input analog signal is first subjected to one-step asynchronous pulse coding to obtain a time-domain quantized and coded pulse request signal Req and a time-domain quantized and coded pulse direction signal Dir. An instant range of change of the signal is obtained by a small change in amplitude divided by a small change in time. In the stage of asynchronous pulse coding of a preceding stage ADC, sampling is performed once every change of a fixed amplitude (LSB) and a time-domain quantized and coded pulse request signal Req pulse is output. Therefore, the instant range of change of the signal can be obtained only by detecting a time interval of the time-domain quantized and coded pulse request signal Req pulse. That is, the time interval Δt_{req} between adjacent Req pulses represents an elapsed time since the signal is changed by a fixed amplitude. As shown in the dotted box in FIG. 1, LSB/Δt_{req} represents a quantized differential information of the signal, and the Dir pulse determines positive and negative signs of differential information. The IROC feature of the signal in the time domain is extracted by mapping each Δt_{req} to a preset time threshold category. Therefore, in the circuit for extracting the feature in the time domain according to the embodiment of the present application, the time interval between two time-domain quantized and encoded pulse request signal Req pulses is detected and it is further detected that whether the time interval satisfies a set threshold time. Situations that the instant range of change of the signal within a period satisfies the set threshold are counted to obtain a statistical result and the statistical result is the finally extracted feature. Each IROC unit in an entire feature extraction module corresponds to a threshold section and thus the circuit for extracting features according to the embodiment of the present application can compare the instant range of change of the signal with a plurality of threshold section in parallel, determine the sign of the instant range of change using the time-domain quantized and encoded pulse direction signal Dir pulse and count a number of the situations that the instant range of change satisfies the set threshold within a certain period. In the embodiment shown in FIG. 2, values of the instant range of change are divided into 8 categories, and the direction is divided into 2 categories, and into a total of 8×2=16 categories.

FIG. 2 is a schematic diagram showing a circuit for extracting features according to an embodiment of the present application. As shown in FIG. 2, the circuit for extracting features in present embodiment includes: one or more feature extracting units, such as IROC Unit 0, IROC Unit 1, . . . , IROC Unit 7. The one or more feature extracting unit are configured to extract and classify an instant range of change (IROC) feature from an input of an asynchronous pulse coding in the time domain.

The input of the asynchronous pulse coding is a pulse request signal and a pulse direction signal obtained by performing time-domain quantization and coding on an analog signal.

It should be noted that: the above-mentioned circuit for extracting features may also include a traditional circuit for extracting features.

When LC-ADC performs asynchronous quantization and encoding on analog signals, coding is performed generally based on equal amplitude, that is, a pulse request signal Req pulse is output when the analog signal change by the same amplitude LSB and the pulse direction signal Dir is configured to record whether the magnitude of the pulse increases or decreases.

In order to make the classification more accurate, a plurality of feature extracting units are generally disposed in the circuit to correspond to a plurality of time thresholds.

When the number of feature extracting units is multiple, these feature extracting units are connected in parallel, that is, all feature extracting units have the same input. The plurality of feature extracting units are disposed to mainly classify input features of asynchronous pulse coding, and the classified features are used to facilitate subsequent data processing. Therefore, each feature extracting unit is configured to extract an instant range of change feature satisfying an elapsed time since an analog signal collected by the sensor node is changed by a fixed amplitude is within the preset time intervals and different feature extracting units correspond to different preset time intervals. That is, each feature extracting unit is configured to extract an instant range of change feature of the pulse request signal satisfying the time interval of adjacent pulses in the pulse request signal is within the preset time interval, the time interval of adjacent pulses in the pulse request signal represents an elapsed duration Δt_{req} since the analog signal is changed by a fixed amplitude LSB. Description is made below by configuring 7 thresholds as an example.

The IROC circuit for extracting features includes 8 parallel IROC units and 16 output channels. Req and Dir are the two inputs of the circuit, and the bias voltage Bias is used as a control signal and used to adjust the time threshold. Seven binary configurable time thresholds (2⁰Th., 2¹Th . . . 2⁶Th) are stored in the circuit, and these seven thresholds divide a time axis into 8 intervals, namely “<2⁰ Th.”, “2⁰Th to 2¹Th”, . . . , “>2⁶Th”. By comparing each Δt_{req} with the above seven thresholds in parallel, the IROC feature will be mapped to an interval of the above eight intervals, a positive or negative sign of the instant range of change of the signal is detected by Dir and the IROC feature is finally mapped to a category of sixteen categories.

In a specific application, the instant range of change feature extracted by the circuit can be obtained by calculating the differential of the change amplitude of the signal to time. In order to adapt the output result of the asynchronous pulse coding of the analog signal in the front-end circuit and simplify the circuit for extracting features, LSB/Δt_{req} is used as the instant range of change feature and then extracted and classified in the embodiment of the present application.

In present embodiment, each feature extracting unit has three input signals and two output signals. The three input signals include: a time-domain quantized and coded pulse request signal Req, a time-domain quantized and coded pulse direction signal Dir, and a bias voltage signal Bias for adjusting the time threshold. The two output signals are used to represent a classification result of the instant range of change feature of the signal whose feature extraction has been completed.

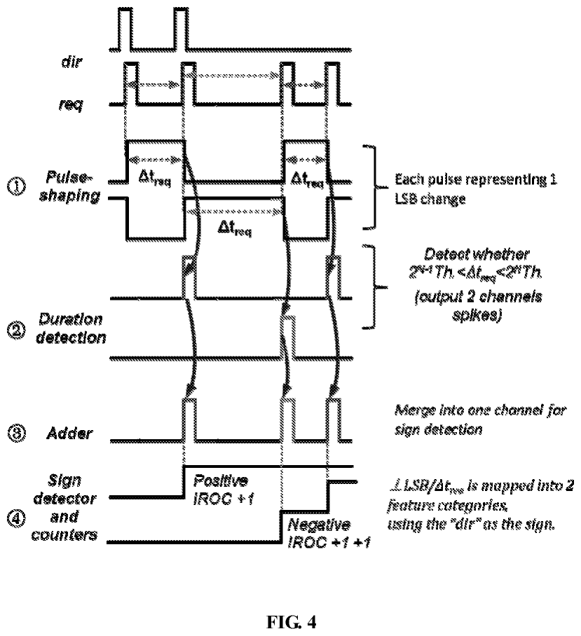

FIG. 3 is a circuit structure diagram of an instant range of change (IROC) unit in a circuit for extracting features according to an embodiment of the present application; and FIG. 4 is an operation timing diagram of the IROC unit in FIG. 3. As shown in FIGS. 3 to 4, each feature extracting unit in present embodiment includes a pulse-shaping module 1, two duration detection modules 2, an adder 3, a sign detection module 4 and two pulse counters 5. The pulse-shaping module is configured to convert the pulse request signal into two ways complementary wide pulse signals. The width of each wide pulse in each way wide pulse signal represents an elapsed time Δt_{req} since the analog signal is changed by a fixed amplitude LSB (least significant bit); complementary wide pulses are output from the pulse-shaping module 1 and all the time intervals between adjacent pulse request signals Req are recorded through two ways complementary wide pulses. The duration detection module is configured to filter wide pulses in the two ways wide pulse signals output by the pulse-shaping module according to the preset time interval and outputs count pulses if the pulse width Δt_{req} of the wide pulse is within the preset time interval. The adder is configured to combine the two ways count pulse signals output by the duration detection module into one way count pulse signal. The sign detection module is configured to assign, to the pulse counter, a corresponding pulse in one way count pulse signal combined by the adder according to the pulse direction signal. The pulse counter is configured to count the number of instant range of change features +LSB/Δt_{req} or −LSB/Δt_{req} that satisfy the preset time interval conditions within a period according to the number of pulses output by the sign detection module. The pulse counter may be asynchronous pulse counter and is mainly configured to count the number of the same instant range of change.

In the present embodiment, in order to facilitate the simple implementation of the circuit, the pulse request signal can be converted into two ways complementary wide pulse signals by detecting a rising edge of each pulse in the pulse request signal, the falling edge can also be detected in practical applications, so that the width of each wide pulse in each way wide pulse signal represents the time interval Δt_{req} between adjacent pulses after the analog signal is coded, that is, an elapsed time Δt_{req} since the analog signal is changed by a fixed amplitude LSB. The wide pulses can be screened and classified by detecting that the time interval Δt_{req} is located in which time section mentioned above. The wide pulses belonging to this time interval can be filtered out since different IROC units correspond to different time intervals and thus the corresponding instant range of change features +LSB/Δt_{req} and −LSB/Δt_{req} can be extracted subsequently. The same instant range of change features +LSB/Δt_{req} and −LSB/Δt_{req} are further classified and counted by sign detecting and pulse counting.

In the embodiment shown in FIG. 3, the pulse-shaping module 1 has one input signal and two outputs, one input signal is the time domain quantized and coded pulse request signal Req and the two output signals are connected to inputs of two duration detection modules 2 correspondingly. The two detection modules are identical. The inputs of the duration detection module 2 further include the bias voltage signal Bias for adjusting the time threshold value. And the two detection modules have been configured same time threshold. The two outputs of the duration detection module 2 are connected to the input of the adder, and the output of the adder 3 is connected to the input of the sign detection module 4. The input of the sign detection module 4 further includes the time domain quantized and coded pulse direction signal Dir of the analog signal and two outputs of the sign detection module 4 are connected to inputs of the two pulse counters 5 correspondingly.

As shown in the timing diagram shown in FIG. 4, during the operation of the feature extracting unit of the above circuit, each feature extracting unit detects a time interval of the input time domain quantized and coded pulse request signal, and compares the time interval with a configured time threshold 2^{N}Th. (N is 0, 1, 2, . . . , 6) to determine whether the instant range of change of the signal is within a configured range, and then determine a positive or negative sign of the instant range of change by the time domain quantized and coded pulse direction signal. The instant range of change has a positive sign if a time domain quantized and coded pulse direction signal pulse occurs while a time domain quantized and coded pulse request signal pulse occurs and has a negative sign if no time domain quantized and coded pulse direction signal pulse occurs while a time domain quantized and coded pulse request signal pulse occurs

Specifically, the pulse-shaping circuit converts one way Req short pulse signal into two ways complementary wide pulses signals, that is, a first wide pulses signal and a second wide pulses signal. Each wide pulse of wide pulses signals represents that the amplitude of the signal is changed by one LSB, and the width of the wide pulse represents the Δt_{req} to be detected. Each of two duration detection modules is configured to compare every input pulse of wide pulses signal with the configured time threshold and then output a pulse when the input pulse width satisfies the time threshold condition. Two ways output signals of the duration detection module are combined into one way pulse signal through the adder used for the subsequent sign detection step. Dir pulse indicates that a direction of the signal of the LC-ADC at the time of sampling is positive. If there is no Dir pulse at the time of sampling, it means that the direction of the signal is negative. Therefore, the sign detection circuit assigns the output pulse of the adder to two counters according to the value of Dir; the two counters are configured to count numbers of +LSB/Δt_{req} and −LSB/Δt_{req}, respectively.

Based on the above embodiment, a plurality of feature extracting units connected in parallel process time-domain pulse signals at the same time, divide values of the instant range of change of the analog signal into N types, and divide the direction of the analog signal into two types. The instant range of change features are divided into 2N types and output, in which N is the number of feature extracting units connected in parallel and is a positive integer greater than or equal to 2.

When the number of N feature extracting units connected in parallel increases, the number of classifications increases accordingly. The more the number of classifications, the finer the information amount extracted and the larger the amount of classified information processed simultaneously.

In the above embodiment, the configured time threshold can be controlled by a biased fixed voltage signal, or can be controlled by a digital signal method.

In practical applications, the feature extracting unit determines a preset time interval for extracting the instant range of change feature according to the time threshold. Each feature extracting unit can pre-store a corresponding time interval, or dynamically configure a time threshold according to requirements for classification accuracy, so as to dynamically adjust the preset time interval for extracting the instant range of change feature.

By the circuit for extracting time domain features according to the embodiment of the present application, the instant range of change of an analog input of the asynchronous pulse coding can be directly extracted and classified in the time domain, and the instant range of change is used as the feature thereof. By adopting this method, converting from the time domain to the frequency domain required by the traditional feature extraction process is avoided, the power consumption overhead is reduced and the signal range of change, also known as the time differential of the signal, contains all the information of the signal in the time domain, and thus the method for extracting the feature of the signal provides lower power consumption without losing information. It has great prospects in the fields of a spiking neural network or a continuous time domain system.

An embodiment of the present application further provides a spiking neural network, including the circuit for extracting features mentioned in above embodiment. The circuit for extracting features may be used as an internal module in an asynchronous spiking neural network.

An embodiment of the present application further provides a digital signal processing system, including the above circuit for extracting features. The circuit for extracting features may be used as an internal module in a continuous time digital signal processing system.

Digital signals include a digitized voice, human biological signals, environmental monitoring signals, security signals and/or human-computer interaction signals.

The environmental monitoring signal includes light, temperature, humidity and/or pH information, the human-computer interaction signals include gesture recognition and/or facial expression recognition information, and the security signals include smoke alarm, fingerprint recognition and/or image recognition information.

Finally, it should be noted that the above embodiments are only used to explain the technical solutions of the present application, and are not limited thereto; although the present application is described in detail with reference to the foregoing embodiments, it should be understood by those skilled in the art that they can still modify the technical solutions described in the foregoing embodiments and make equivalent replacements to a part of the technical features and these modifications and substitutions do not depart from the scope of the technical solutions of the embodiments of the present application.

What is claimed is:

1. A circuit for extracting features, comprising: one or more feature extracting units, configured to extract and classify an instant range of change (IROC) feature from inputs of an asynchronous pulse coding in the time domain, wherein the inputs of the asynchronous pulse coding comprise a pulse request signal and a pulse direction signal obtained by performing time-domain quantization and coding on an analog signal.

2. The circuit of claim 1, wherein when the number of feature extracting units is multiple, the feature extracting units are connected in parallel, each feature extracting unit is configured to extract an instant range of change feature of the pulse request signal satisfying the time interval of adjacent pulses in the pulse request signal is within the preset time interval, different feature extracting units correspond to different preset time intervals and the time interval of adjacent pulses in the pulse request signal represents an elapsed duration Δt_{req} since the analog signal is changed by a fixed amplitude LSB.

3. The circuit of claim 1, wherein the instant range of change feature is obtained by calculating the differential of the signal variation amplitude to time.

4. The circuit of claim 1, wherein each feature extracting unit has three ways input signals and two ways output signals.

5. The circuit of claim 4, wherein the three ways input signals comprise: a time-domain quantized and coded pulse request signal, a time-domain quantized and coded pulse direction signal, and a bias voltage signal for adjusting a time threshold and the two ways output signals are configured to represent a classification result of the instant range of change feature has been completely extracted.

6. The circuit of claim 5, wherein each feature extracting unit comprises a pulse-shaping module, two duration detection modules, an adder, a sign detection module and two pulse counters in which,
the pulse-shaping module is configured to convert the pulse request signal into two ways complementary wide pulse signals and a width of every wide pulse in each way wide pulse signal represents an elapsed time Δt_{req} since the analog signal is changed by a fixed amplitude LSB,
the two duration detection modules are configured to screen wide pulses in the two ways wide pulse signals output by the pulse-shaping module according to the preset time interval and output count pulses if the pulse width Δt_{req} of the wide pulse is within the preset time interval,
the adder is configured to combine the two ways count pulse signals output by the duration detection module into a count pulse signal,
the sign detection module is configured to assign, to the two pulse counters, a corresponding pulse in one way count pulse signal combined by the adder according to the pulse direction signal, and
the two pulse counter are configured to count the number of instant range of change features +LSB/Δt_{req} and −LSB/Δt_{req} that satisfy the preset time interval conditions within a period according to the number of pulses output by the sign detection module, respectively.

7. The circuit of claim 6, wherein the pulse-shaping module has one way input signal and two ways output signals, one way input signal is the time domain quantized and coded pulse request signal and the two ways output signals are connected to inputs of the two duration detection module, correspondingly,
the inputs of the duration detection module further comprise a bias voltage signal for adjusting the time threshold value,
the two outputs of the duration detection module are connected to the input of the adder, and the output of the adder is connected to the input of the sign detection module,
the input of the sign detection module further comprises the time domain quantized and coded pulse direction signal of the analog signal, and
two way outputs of the sign detection module are connected to inputs of the two pulse counters correspondingly.

8. The circuit of claim 5, wherein each feature extracting unit detects a time interval of the input time domain quantized and coded pulse request signal, and compares the time interval with a configured time threshold to determine whether the instant range of change of the signal is within a configured range, and then determine a positive or negative sign of the instant range of change by the time domain quantized and coded pulse direction signal; the instant range of change has a positive sign if a time domain quantized and coded pulse direction signal pulse occurs while a time domain quantized and coded pulse request signal pulse occurs and has a negative sign if no time domain quantized and coded pulse direction signal pulse occurs while a time domain quantized and coded pulse request signal pulse occurs

9. The circuit of claim 8, wherein a plurality of feature extracting units connected in parallel are configured to process time-domain pulse signals at the same time, divide values of the instant range of change of the analog signal into N types, and divide the direction of the analog signal into two types, the instant range of change features are divided into 2N types and output, in which,
N is the number of feature extracting units connected in parallel and is a positive integer greater than or equal to 2

10. The circuit of claim 8, wherein the configured time threshold is controlled by a biased voltage signal or by a digital signal method.

11. The circuit of claim 5, wherein the feature extracting unit determines a preset time interval for extracting the instant range of change feature according to the time threshold.

12. A spiking neural network, comprising the circuit for extracting features according to any one of claim 1.

13. A digital signal processing system, comprising the circuit for extracting features according to any one of claim 1.

14. The digital signal processing system of claim 13, wherein the digital signal comprises a digitized voice, human biological signals, environmental monitoring signals, security signals and/or human-computer interaction signals.
